(19) United States
(12) Patent Application Publication
(10) Pub. No.: US 2012/0281153 A1
(43) Pub. Date: Nov. 8, 2012

(54) LIGHTING DEVICE, DISPLAY DEVICE AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/521,450

(22) PCT Filed: Jan. 11, 2011
(86) PCT No.: PCT/JP2011/050247

§ 371 Date: Jul. 11, 2012

(30) Foreign Application Priority Data
Jan. 29, 2010 (JP) 2010-018368

(51) Int. Cl. F21V 8/00; H04N 3/10; G02F 1/13357

(52) U.S. Cl. 348/790; 362/632; 362/634; 362/602; 349/65; 348/E03.011

(57) ABSTRACT

A lighting device that achieves a small housing member and an appropriate positioning of an optical member is provided. The lighting device includes an LED board 40, a light guide plate 31 including an end surface 33 facing the LED board 40, an optical sheet 50 covering a light exit surface 31a of the guide plate 31, a positioning member P positioning the optical sheet 50 such that the optical sheet 50 is positioned with respect to the guide plate 31 in a planer direction, and a chassis 60. The positioning member P includes a positioning hole 55 formed in the optical sheet 50 and a positioning pin 35 provided on the guide plate 31 and configured to be fitted through the hole 55. The pin 35 is passed and fitted through the hole 55 and thus the optical sheet 50 is positioned with respect to the guide plate 31. The pin 35 is formed on the guide plate 31 and the chassis 60 as a housing member is not increased in size.

### TECHNICAL FIELD

The present invention relates to a lighting device, a display device and a television receiver.

### BACKGROUND ART

For example, a liquid crystal panel used for a liquid crystal display device such as a liquid crystal television does not emit light, and thus a backlight unit is required as a separate lighting device. A type of a backlight unit is broadly divided into a direct type and an edge-light type according to the configurations of the backlight unit. An edge-light-type backlight unit includes light sources, a light guide plate, an optical sheet and a housing member that houses those components (Patent Document 1).

Preferably, the optical member such as an optical sheet is positioned so as not to be moved therefrom. For example, a method of positioning the optical sheet is proposed as follows. Positioning pins are provided in a housing member, and the positioning pins are fitted through holes formed in the optical sheet. This kind of positioning method is disclosed in Patent Document 2.

Patent Document 1: Japanese Unexamined Patent Publication No. 2008-293902

Patent Document 2: Japanese Unexamined Patent Publication No. 2009-139572

### Problem to be Solved by the Invention

If positioning pins are provided in a housing member, the positioning pins are needed to be away from a light guide plate and a light source. The positioning pins are positioned outside the light guide plate and the light source, and thus the housing member is necessarily great in size. However, the housing member (a frame of the housing member) is preferably as small as possible, and improvement can be made in this point.

### DISCLOSURE OF THE PRESENT INVENTION

The present invention was accomplished in view of the above circumstances. It is an object of the present invention to provide a lighting device in which a housing member is small and an optical member is properly positioned. Another object of the present invention is to provide a display device including the lighting device and a television receiver including the display device.

### Means for Solving the Problem

A lighting device according to the present invention includes a light source, a light guide plate, an optical member, a positioning member and a housing member. The light guide plate includes a light exit surface and an end surface facing the light source, the light guide plate configured to guide light entering the end surface to the light exit surface. The optical member provided to cover the light exit surface of the light guide plate. The housing member houses the light source, the light guide plate and the optical member. The positioning member positions the optical member with respect to the light guide plate in a planar direction. The positioning member includes a positioning hole formed in the optical member and a positioning pin provided on the light guide plate and configured to be fitted through the positioning hole.

In the lighting device, the positioning pin is fitted through the positioning hole, and thus the optical member is positioned with respect to the light guide plate. The positioning pin is provided on the light guide plate, and therefore, the housing member is not increased in size.

Following configurations may be preferable.

The positioning pin may be provided in an upper portion of the light guide plate and the optical member may be hung with the positioning pin. With such a configuration, the bottom side of the optical member is movably provided. Even if the light guide plate is expanded or contracted due to heat from the light source, the optical member is not wrinkled.

The positioning pin may be formed integrally with the light guide plate. With such a configuration, the number of parts is not increased. This provides a cost advantage.

The lighting device may further include a holddown member including a holddown wall configured to come in contact with a top of the positioning pin provided on the light guide plate and to hold the light guide plate with the housing member therebetween. With such a configuration, the position of the light guide plate can be maintained in a depth direction of the lighting device.

The positioning pin may have a height greater than a thickness of the optical member. With such a configuration, a certain gap is provided between the optical member and the holddown wall. If there is no gap, the optical member is held by the holddown wall and is likely to be wrinkled. This is unlikely to occur in such a configuration.

The positioning pin may be provided so as not to overlap the light source. With such a configuration, the positioning pin is provided outside optical paths of light emitted from the light source. If the positioning pin is provided within the optical paths, light reflection may vary because of reflection on the poisoning pin, and accordingly, the brightness of light is likely to be uneven. This is unlikely to occur in such a configuration. The configuration hardly affects the lighting performance.

The positioning hole may include a plurality of positioning holes. One of the positioning holes has a clearance with respect to the positioning pin that is smaller a clearance of another one of the positioning holes. With such a configuration, the optical member is accurately positioned with respect to the light guide plate through at least one of the positioning holes with a small clearance. Other positioning pins can be fitted through other positioning holes relatively easily.

The positioning hole may include a plurality of positioning holes. The positioning holes may increase in size as may be closer to a periphery side of the optical member from a middle thereof. With such a configuration, the optical member can be positioned in the middle of the light guide plate (in the middle of the display). In addition, there is an allowable clearance between the pins and holes in the periphery side, and thus the positions of the pins and the holes are easily matched.

Next, to solve the above problem, a display device according to the present invention may include the above lighting device and a display panel configured to provide display using light from the lighting device. Furthermore, a television receiver according to the present invention may include the above lighting device. The display panel may be a liquid crystal panel. The display device as a liquid crystal display device has a variety of applications, such as a television display or a personal-computer display. Particularly, it is suitable for a large screen display.

### Advantageous Effect of the Invention

According to the present invention, a lighting device in which a housing member (a frame of a housing member) is small and an optical member is properly positioned can be provided. Furthermore, the display device and the television receiver including the lighting device are provided.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a display device included in the television receiver;

FIG. 3 is a cross-sectional view of the display device taken in the Y-axis direction;

FIG. 4 is a perspective view illustrating a construction for positioning an optical sheet;

FIG. 5 is a magnified view of a part of FIG. 3;

FIG. 6 is a cross-sectional view of the display device taken in the X-axis direction;

FIG. 7 is a perspective view illustrating a construction for positioning the optical sheet according to a second embodiment of the present invention; and

FIG. 8 is a perspective view illustrating a construction for positioning the optical sheet according to a third embodiment of the present invention.

### BEST MODE FOR CARRYING OUT THE INVENTION

### First Embodiment

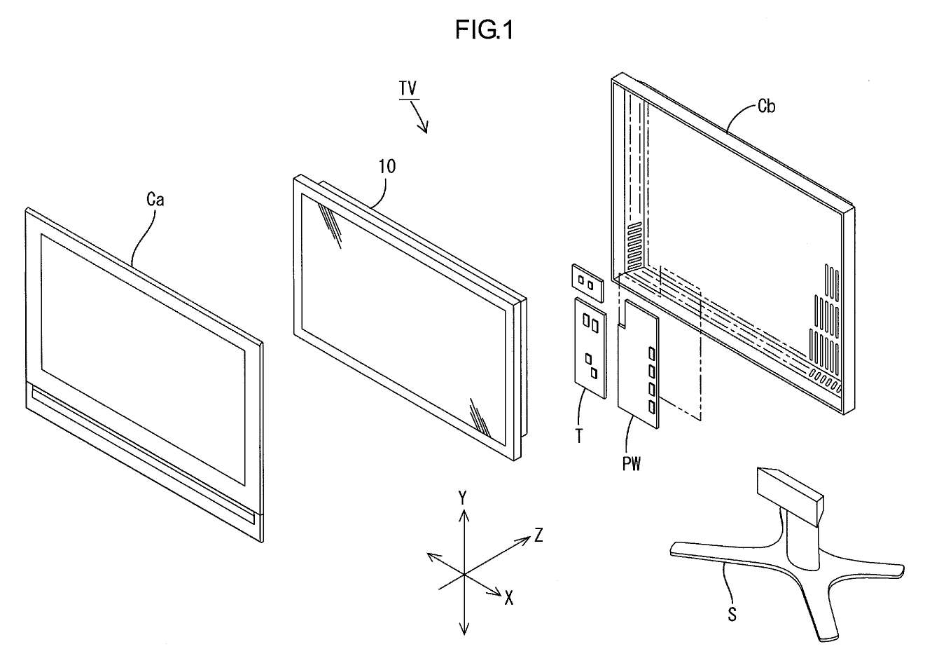

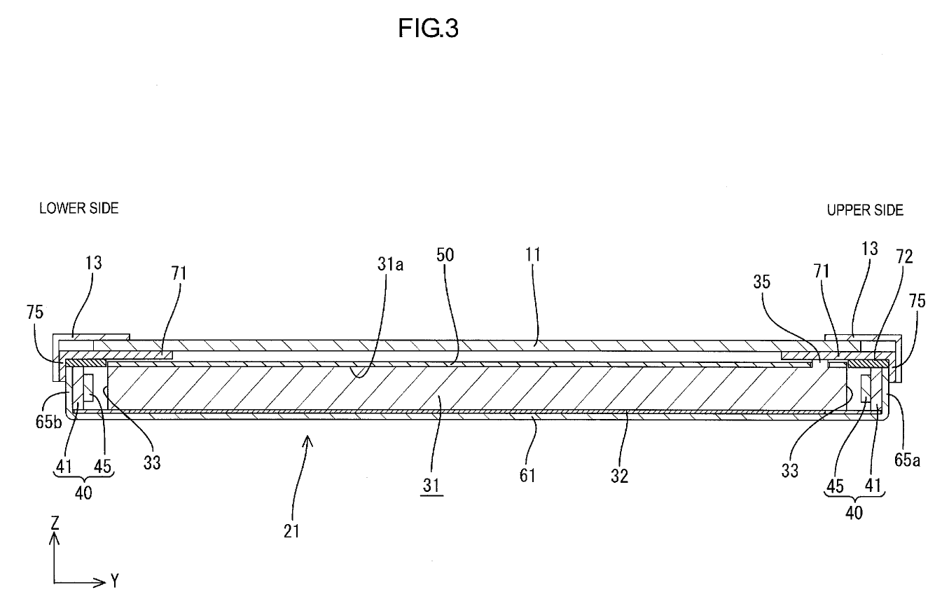

A first embodiment according to the present invention will be described with reference to FIGS. 1 to 6. As illustrated in FIG. 1, the television receiver TV of the present embodiment includes the display device 10, front and rear cabinets Ca, Cb which house the display device 10 therebetween, a power source PW, a tuner T and a stand S.

An entire shape of the display device 10 is a landscape rectangular. The display device 10 includes a liquid crystal panel 11 as a display panel and a lighting device 21 as an external light source. A lateral width direction (long-side direction) of the display device 10 is described as an X axis direction. A height direction (short-side direction) of the display device 10 is described as a Y axis direction. A depth direction of the display device 10 is described as a Z axis direction.

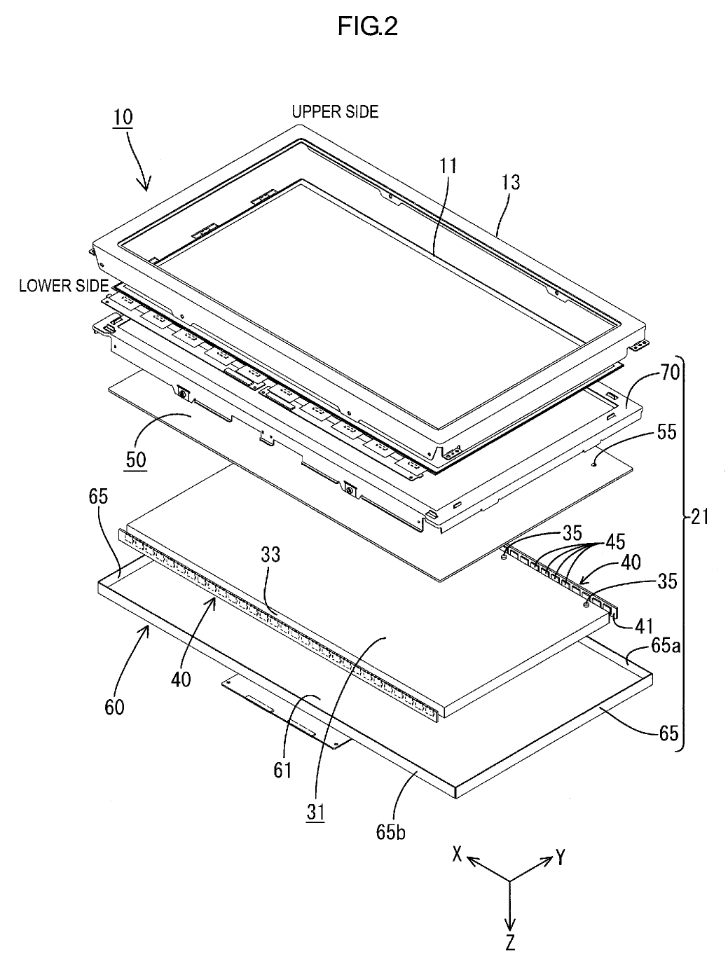

The liquid crystal panel 11 is formed in an elongated rectangular shape as illustrated in FIG. 2. The liquid crystal panel 11 is configured such that a pair of glass substrates is bonded together with a predetermined gap therebetween and liquid crystal is sealed between the glass substrates. On one of the glass substrates, switching components (e.g., TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. Polarizing plates are attached to outer surfaces of the substrates.

As illustrated in FIG. 2, the lighting device 21 includes a light guide plate 31, a pair of LED boards 40, an optical sheet 50 (an example of “optical member” in the present invention), a chassis 60 (an example of “housing member” in the present invention) that houses the light guide plate 31, the pair of LED boards 40 and the optical sheet 50, and a holddown member 70.

The chassis 60 is made of metal and formed in an elongated rectangular shape. The chassis 60 includes a bottom plate 61 and side plates 65 each of which rises from an outer edge of the corresponding side of the bottom plate 61. An entire shape of the chassis 60 is a substantially shallow box shape opened to the front surface side as a display surface side. The bottom plate 61 has a flat surface. In the middle of the surface, the light guide plate 31 is provided.

The light guide plate 31 directs light that enters a light entrance surface to a front surface 31a that is a light exit surface. The light guide plate 31 is made of a resin with high transparency (such as acrylic). The light guide plate 31 is formed in an elongated rectangular shape similar to the liquid crystal panel 11. A reflection sheet 32 is provided on the rear surface side of the light guide plate 31. The light guide plate 31 is arranged in the middle of the bottom plate 61 such that the front surface 31a faces upward. The front surface 31a is the light exit surface. The light guide plate 31 is positioned so as not to move in a plane direction with respect to the chassis 60 by a positioning member (not shown).

End surfaces 33 of the light guide plate 31 (surfaces arranged on ends in the Y-axis) are light entrance surfaces. The light sources are mounted on a surface of the side plates 65a and 65b among the side plates 65 of the chassis 60. The side plates 65a and 65b face the end surfaces 33 of the light guide plate 31. LED boards 40 are mounted on inner walls of the side plates 65a and 65b such that the light emitting surfaces face the end surfaces 33 of the light guide plate 31.

Each of the LED boards 40 includes a base member 41 and the LEDs (light emitting diodes) 45 mounted on the base member 41. The base member 41 is made of metal such as aluminum material similar to the chassis 60 and a wiring pattern (not shown) made of a metallic film such as copper foil is formed on a surface of the base member 41 via an insulating layer. The base member 41 extends in the long-side direction of the light guide plate 31. The LEDs 45 are arranged in a line at equal intervals on the front surface of the base member 41. Each of the LEDs 45 is a white-light emitting diode configured by sealing an LED chip with a resin material and formed in a rectangular plan view shape.

The optical sheet 50 is formed in an elongated rectangular shape similar to the liquid crystal panel 11, and is formed in a thin-sheet shape. A specific optical sheet 50 may include a diffuser sheet, a lens sheet, a reflecting type polarizing sheet, and any one of them may be selected to be used.

The optical sheet 50 includes layers laminated on the front surface 31a side of the light guide plate 31 and covers almost entire front surface 31a of the light guide member 31. The optical sheet 50 is positioned by a positioning member P so as not to move along the light guide plate 31. The positioning member P includes positioning pins 35 integrally formed with the light guide plate 31 and positioning holes 55 formed in the optical sheet 50.

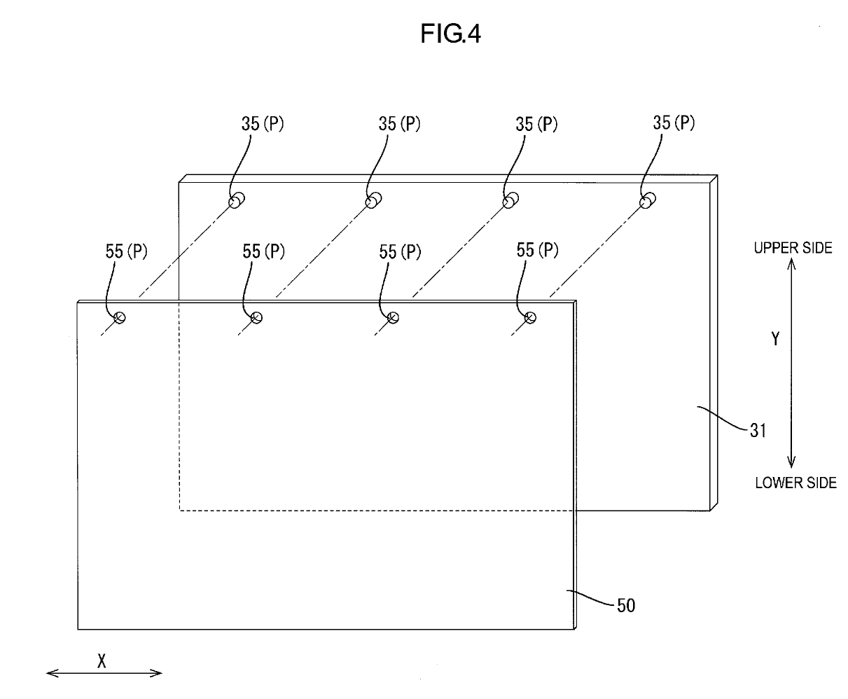

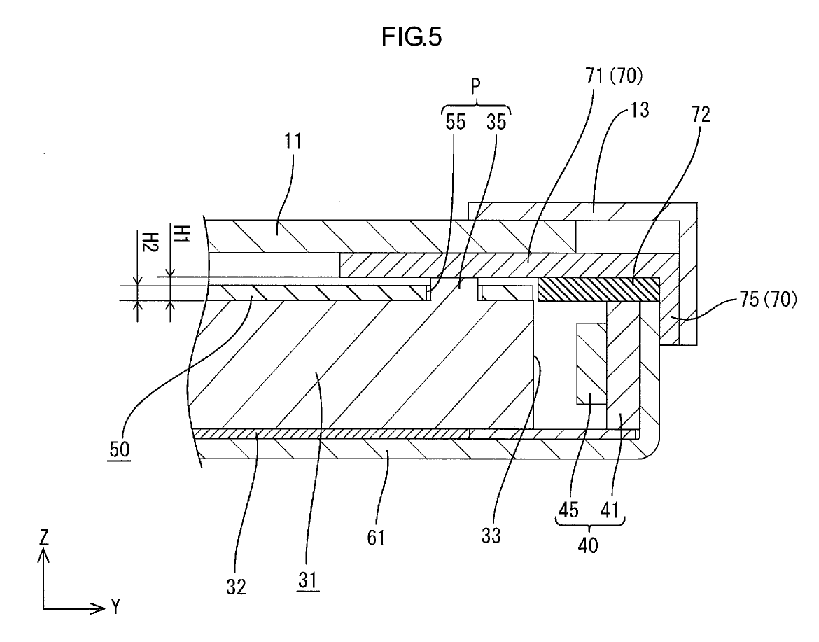

The positioning pins 35 are provided on the front surface 31a of the light guide plate 31 that is outside a display area of the liquid crystal panel 11. Specifically, as illustrated in FIG. 4, the positioning pins 35 are provided in an upper portion of the light guide plate 31 and two positioning pins 35 are provided in a middle portion of the light guide plate 31 and two positioning pins 35 are provided close to ends of the light guide plate 31 (four positions in total). Here, “upper” means an upper side of the display device 10 if the device stands up as illustrated in FIG. 1. Each of the positioning pins 35 is formed in a pillar shape and protrudes frontward. A pin height H1 of each positioning pin (height of each pin from the front surface of the light guide plate) is greater than the thickness H2 of the optical sheet 50 (see FIG. 5).

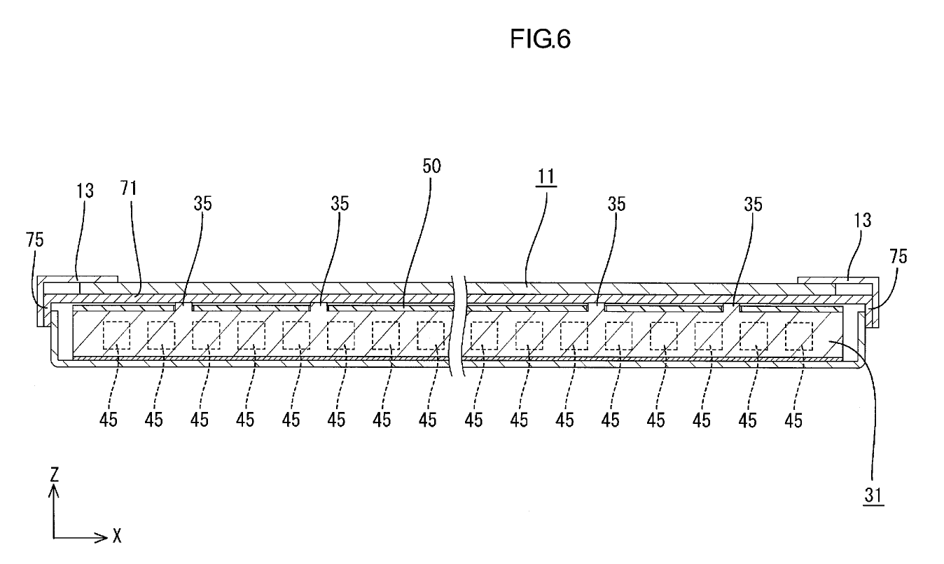

The positional relationships between the positioning pins 35 and the LEDs 45 are illustrated in FIG. 6. Each of the positioning pins 35 is provided between the LEDs 45 that are arranged in a line and provided so as not to overlap the LED 45 in the Z-axis direction (in other words, provided to be shifted in the X-axis direction from the LEDs 45).

The positioning hole 55 is formed so as to correspond to the positioning pin 35 formed with the light guide plate 31. The positioning holes 55 are formed in the upper portion of the optical sheet 50 and two positioning holes 55 are formed in the middle portion of the optical sheet 50 and two positioning holes 55 are formed close to ends thereof (four positions in total). Each positioning hole 55 and each positioning pin 35 form a pair, and each of the positioning pins 35 is fitted through the corresponding positioning hole 55.

As described above, each positioning pin 35 is fitted through each positioning hole 55 formed in the optical sheet 50, and thus the optical sheet 50 is positioned so as not to move along a plane of the light guide plate 31 (an X-Y plane). In the present embodiment, the positioning pins 35 and the positioning holes 55 are formed only in the upper portion of the light guide plate 31 and the upper portion of the optical sheet 50. Accordingly, the optical sheet 50 is hung with the positioning pins 35 when the lighting device 21 stands up.

As illustrated in FIG. 2, the holddown member 70 is formed in a frame shape and extends along the outer periphery of the light guide plate 31. The holddown member 70 is made of a synthetic resin (a black-color synthetic resin having a high light blocking effect), and formed in an L-shape in a cross-sectional view. The holddown member 70 is mounted over the chassis 60 so as to cover and hold the chassis 60. A side wall 75 of the holddown member 70 is fitted to the outer surface of the side plate 65 of the chassis 60. A front surface wall 71 (an example of a “holddown wall” in the present invention) overlaps the outer periphery of the light guide plate 31.

The front surface wall 71 of the holddown member 70 is in contact with the top of the positioning pin 35 that is formed with the light guide plate 31. The front surface wall 71 and the bottom plate 61 of the chassis 60 hold the light guide plate 31 therebetween with pressed (see FIG. 5). A reflection sheet 72 is attached to the rear surface of the front surface wall 71. The reflection sheet 72 is provided on a side of the LEDs 45 and reflects light that leaks to the side of the LEDs 45 and direct the light to the light guide plate 31.

The liquid crystal panel 11 is provided on the top surface of the holddown member 70 such that the front surface wall 71 overlaps the outer periphery of the liquid crystal panel 11. A frame shaped bezel 13 is mounted on the front surface of the liquid crystal panel 11, and therefore, the liquid crystal panel 11 is integrally held in the lighting device 21.

In the lighting device 21, light that is emitted from the LEDs 45 enters the end surfaces 33 and travels through the inside of the light guide plate 31 with being diffused. The light is reflected by the reflection sheet 32 that is provided on the rear surface of the light guide plate 31. The light is directed to the front surface 31a that is the light exit surface. Accordingly, strong light is exited from the top surface 31a of the light guide plate 31. The light is exited with diffused evenly by the optical sheet 50 that is provided on the top surface side 31a of the light guide plate 31, and therefore, the liquid crystal panel 11 is illuminated uniformly with the light from the rear side of the liquid crystal panel 11.

Next, the effects of the display device 10 will be explained. The positioning pins 35 are fitted through the positioning holes 35. Accordingly, the optical sheet 50 is positioned with respect to the light guide plate 31 in the lighting device 10. The positioning pins 35 are formed with the light guide plate 31. Accordingly, it is not necessary to prepare space for arranging the positioning pins 35 in the chassis 60. This reduces a size of the chassis 60 (having a small frame shape).

The positioning pins 35 are provided in the upper portion of the light guide plate 31 and the optical sheet 50 is hung with the positioning pins 35. With such a configuration, the bottom portion of the optical sheet 50 is movably provided. Even if the light guide plate 31 is extracted and contracted due to heat from the LEDs 45, the optical sheet 50 is not wrinkled.

In the display device 10, the height of the positioning pin 35 is greater than the thickness of the optical sheet 50. With such a configuration, a certain gap is provided between the front surface wall 71 of the holddown member 70 and the optical sheet 50. If no gap is provided, the front surface wall 71 holds and presses the optical sheet 50 and the optical sheet 50 is likely to be wrinkled. This does not occur in such a configuration.

The positioning pins 35 are provided not to overlap the LEDs 45. With such a configuration, the positioning pins 35 are arranged outside optical paths of light emitted from the LEDs 45. If the positioning pins 35 are arranged in the optical paths, light reflection may vary and the brightness of light is likely to be uneven. However, this does not occur in such a configuration and excellent lighting performance is always achieved.

### Second Embodiment

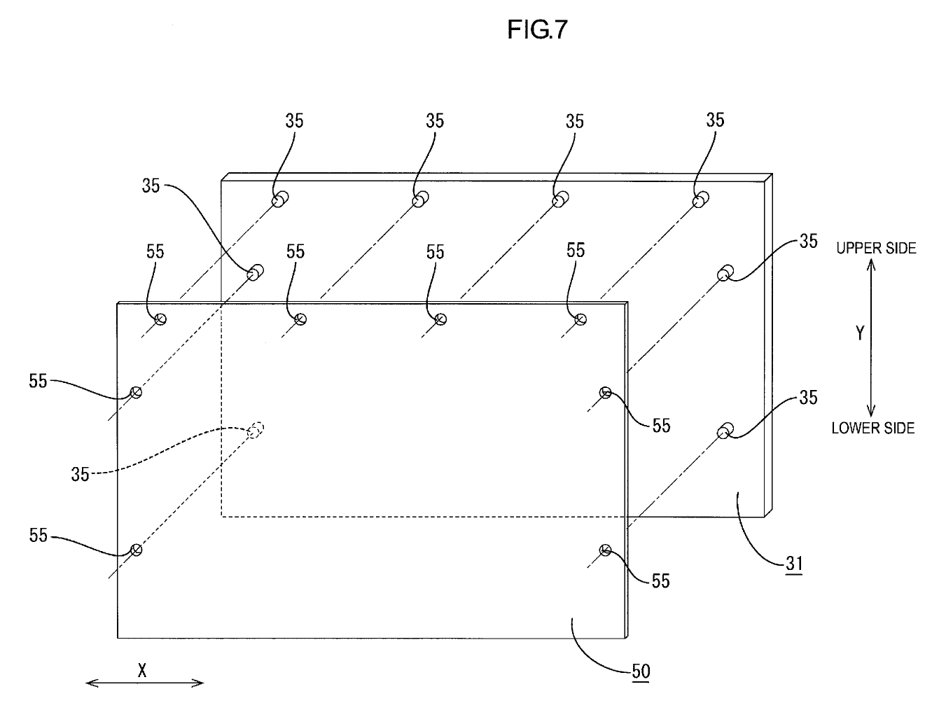

Next, a second embodiment according to the present invention will be described with reference to FIG. 7. In the first embodiment, as illustrated in FIG. 4, four positioning pins 35 are provided in the upper portion of the light guide plate 31 and the optical sheet 50 is hung with the positioning pins 35. In the second embodiment, as illustrated in FIG. 7, two positioning pins 35 are additionally provided on each end portion in the X-axis direction of the light guide plate. The optical sheet 50 is hung with eight positioning pins 35 in total.

The positioning pins 35 receive the load required to support the optical sheet 50. With such a configuration, the load applied to each positioning pin 35 is decreased, and thus the optical sheet 50 is hung stably. Furthermore, the number of contact points between the light guide plate 31 and the front surface wall 71 is increased from four to eight. Therefore, the holddown member 70 properly holds the light guide plate 31.

### Third Embodiment

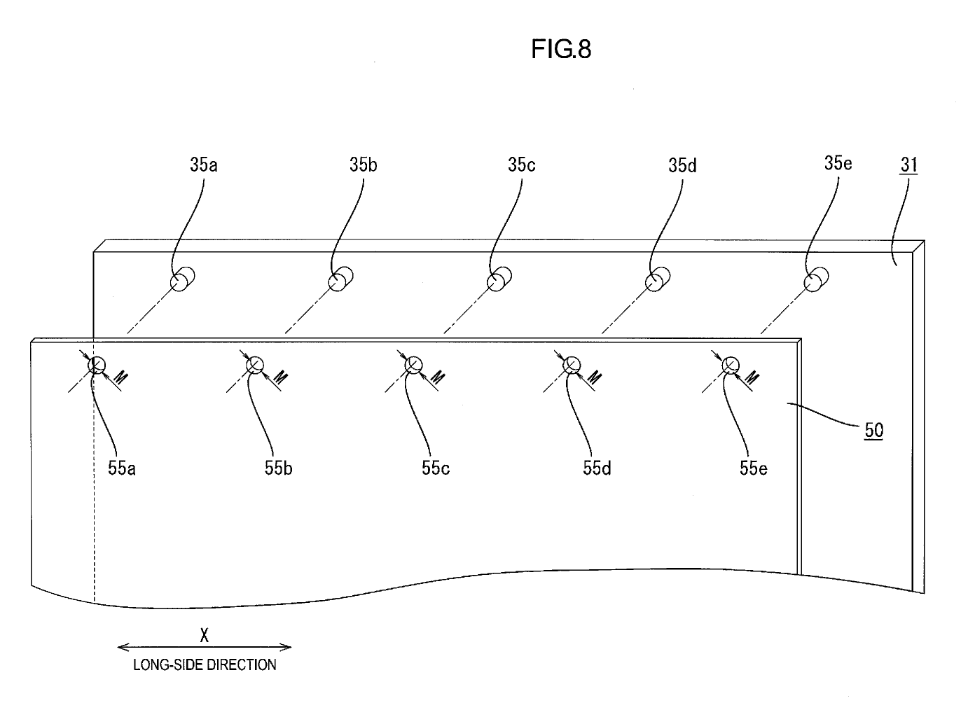

Next, a third embodiment according to the present invention will be described with reference to FIG. 8. In the third embodiment, similar to the first embodiment, the positioning pins 35 are provided in the upper portion of the light guide plate 31 and fitted through the positioning holes 55 in the optical sheet 50. Accordingly, the optical sheet 50 is hung with the positioning pins 35.

Unlike the first embodiment, in the present embodiment, the number of positioning pins 35 and the number of positioning holes 55 are changed from four (even number) to five (odd number) and a hole diameter M of each positioning hole is changed according to the positions thereof. Specifically, in the third embodiment, as illustrated in FIG. 8, the five positioning pins 35a, 35b, 35c, 35d and 35e are arranged in a line. The five positioning holes 55a, 55b, 55c, 55d and 55e are formed in a line in the upper portion of the optical sheet 50 corresponding to the positioning pins 35a to 35e on the light guide plate 31 side. A hole diameter M of each of the five positioning holes 55a to 55d is increased in a gradual manner as is closer to the periphery (ends of the long-side) of the optical sheet 50 from the middle (the middle of the long-side) thereof.

Accordingly, among the five positioning holes 55a to 55e, the positioning hole 55c provided in the middle of the optical sheet 50 has the smallest hole diameter M. Each of the positioning holes 55b and 55d formed in right and left sides of the positioning hole 55c has a second smallest hole diameter M. Each of the positioning holes 55a and 55e formed at the ends in the X-axis of the optical sheet 50 has the greatest hole diameter M. Each of the positioning pins 35a to 35e has a same diameter.

As described above, the clearance (space) generated in the positioning hole 55 with respect to the positioning pins 35 becomes greater as is closer to the peripheral portions (the ends in a longitudinal direction) from the middle portion of the optical sheet 50. With such a configuration, the positioning pins 35 are easily fitted through the positioning holes 55 on the periphery side that allow loose fitting. Therefore, the positioning pins 35 are positioned with respect to the positioning holes 55 with easy (setup) operation. Furthermore, the clearance between the positioning holes and the positioning pins is small in the middle portion and this causes tight fitting. Therefore, the optical sheet 50 is positioned in the middle of the light guide plate 31 with high accuracy without positional displacement. Therefore, with such a configuration, the optical sheet 50 is positioned properly with easy operation.

### Other Embodiments

The present invention is not limited to the above embodiments described in the above description and the drawings. The following embodiments are also included in the technical scope according to the present invention, for example.

(1) In the first to third embodiments, the positioning pins 35 are integrally formed with the light guide plate 31. However, the positioning pins 25 may be provided separately from the light guide plate 31.

(2) In the first to third embodiments, the positioning pin 35 and the positioning hole 55 are formed in a circular shape. However, the positioning pin 35 and the positioning hole 55 may be formed in any shape as long as they are fitted to each other, and the pin 35 and the hole 55 may be formed in other shapes, for example, in a rectangular shape.

(3) In the first embodiment, the optical sheet 50 is positioned by four positioning pins 35 provided in the light guide plate 31. However, the number of positioning pins may not be limited to four but may be two or more.

(4) In the first embodiment, the optical sheet 50 is a single sheet. However, the number of optical sheets 50 may be two or more. With such a configuration, the positioning holes 55 are formed in each optical sheet 50. The positioning pins 35 of the light guide plate 31 may be passed through the positioning holes 55 of each optical sheet 50, and the positioning pins 35 may be fitted through each optical sheet 50.

(5) In the first to third embodiment, the optical sheet 50 is explained as an example of an optical member according to the present invention. The optical member includes a diffuser.

(6) In the third embodiment, the hole diameter M of the positioning hole 55 increases from the middle to the periphery of the light guide plate in a gradual manner. This achieves an easy setup operation and an accurate positioning property. To obtain such an effect, a clearance in at least one of the positioning holes 55 with respect to the positioning pin 35 may be set to be smaller than the clearance in other positioning holes 55. According to the configuration in the third embodiment, the hole diameters M of four out of the five positioning holes 55a to 55e are set to be relatively greater than the diameters of the corresponding positioning pins 35a to 35e, and accordingly, relatively large clearances are provided in the positioning holes 55 with respect to the corresponding positioning pins 35. The hole diameter M of the rest one of the five positioning holes 55 is set to be small such that a clearance between the rest one of the positioning holes 55 and the corresponding positioning pin 35 is small. With such a configuration, the positioning pin 35 is fitted through the positioning hole 55 with a small clearance. Therefore, the optical sheet 50 is positioned with high accuracy with respect to the light guide plate 31. Furthermore, the positioning pins 35 are easily fitted through the four positioning holes 55 with relatively large clearances, thereby providing good setup operation property.

(7) In the above embodiments, the LED board on which the LED is used as an emitting diode is explained as a light source. However, a cold cathode tube or a hot cathode tube, or an organic EL may be used as the light source.

(8) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(9) In the above embodiments, the liquid crystal display device including the liquid crystal panel as a display panel. The technology can be applied to display devices including other types of display components.

(10) In the above embodiments, the television receiver including the tuner is used. However, the technology can be applied to a display device without a tuner.

### EXPLANATION OF SYMBOLS

10: display device, 11: liquid crystal panel, 21: lighting device, 31: light guide plate, 31a: front surface (an example of a “light exit surface” in the present invention), 33: end surface, 35: positioning pin, 40: LED board, 45 LED (an example of a “light source” in the present invention), 50: optical sheet (an example of an “optical member” in the present invention), 55: positioning hole, 60: chassis (an example of “housing member” in the present invention), 70: holddown member, 71: front surface wall (an example of “holddown wall” in the present invention) TV: television receiver, P: positioning member

1. A lighting device comprising:
a light source;
a light guide plate including a light exit surface and an end surface facing the light source, the light guide plate configured to guide light entering the end surface to the light exit surface;
an optical member provided to cover the light exit surface of the light guide plate;
a housing member housing the light source, the light guide plate and the optical member; and
a positioning member positioning the optical member with respect to the light guide plate in a planer direction, the positioning member including a positioning hole formed in the optical member and a positioning pin provided on the light guide plate and configured to be fitted through the positioning hole.

2. The lighting device according to claim 1, wherein the positioning pin is provided in an upper portion of the light guide plate and the optical member is hung with the positioning pin.

3. The lighting device according to claim 1, wherein the positioning pin is formed integrally with the light guide plate.

4. The lighting device according to claim 1, further comprising a holddown member including a holddown wall configured to come in contact with a top of the positioning pin provided on the light guide plate and to hold the light guide plate with the housing member therebetween.

5. The lighting device according to claim 4, wherein the positioning pin has a height greater than a thickness of the optical member.

6. The lighting device according to claim 1, wherein the positioning pin is provided so as not to overlap the light source.

7. The lighting device according to claim 1, wherein:
the positioning hole includes a plurality of positioning holes; and
one of the positioning holes has a clearance with respect to the positioning pin that is smaller than a clearance of another one of the positioning holes.

8. The lighting device according to claim 1, wherein:
the positioning hole includes a plurality of positioning holes; and
the positioning holes increase in size as are closer to a periphery side of the optical member from a middle thereof.

9. A display device comprising:
the lighting device according to claim 1; and
a display panel configured to provide display using light from the lighting device.

10. The display device according to claim 9, wherein the display panel is a liquid crystal panel using liquid crystals filled between base boards.

11. A television receiver comprising the display device according to claim 9.
